(19) United States
(12) Patent Application Publication
(10) Pub. No.: US 2023/0332297 A1
(43) Pub. Date: Oct. 19, 2023

(54) ULTRAFAST PICKLING METHOD AND INSTALLATION THEREFOR

(71) Applicant: Centre de Recherches Metallurgiques ASBL -Centrum voor Research in de Metallurgie vzw, BRUSSELS (BE)

(72) Inventors: Sebastien FLAMENT, VIEUX WALEFFE (BE); Hugo UIJTDEBROEKS, HASSELT (BE); Victor TUSSET, OUPEYE (BE); Jean-Francois NOVILLE, MILMORT (BE); Julien SMAL, ROCOURT (BE)

(21) Appl. No.: 18/044,582

(22) PCT Filed: Sep. 8, 2021
(86) PCT No.: PCT/EP2021/074710

§ 371 Date: Mar. 9, 2023

(30) Foreign Application Priority Data
Sep. 11, 2020 (EP) 20195838.6

(51) Int. Cl. C23G 1/02; C23G 3/02; C23G 1/19

(52) U.S. Cl. CPC C23G 3/025; C23G 1/02; C23G 1/19; C23G 3/021

(57) ABSTRACT

A pickling installation for applying a pickling treatment to a metal strip in continuous movement, the pickling treatment using an acid solution, the pickling installation including: a plurality of cascading treatment tanks among which at least one treatment tank includes a spray/injection section for spraying/injecting the acid solution on the metal strip; and collection means for retrieving the sprayed acid solution after use and redirecting the sprayed acid solution to each spray/injection section. The at least one treatment tank has a first header in front of a first face of the metal strip and a second header in front of a second face of the metal strip. In a first treatment tank configuration, each of the first header and the second header have an internal flat surface intended to be parallel respectively to first and second faces of metal strip, and at a distance thereof.

### CROSS-REFERENCE TO PRIOR APPLICATIONS

This application is a U.S. National Phase application under 35 U.S.C. § 371 of International Application No. PCT/EP2021/074710, filed on Sep. 8, 2021, and claims benefit to European Pat. Application No. EP 20195838.6, filed on Sep. 11, 2020. The International Application was published in English on Mar. 17, 2022 as WO/2022/053515 under PCT Article 21(2).

### FIELD

The present invention relates to a fast method for the pickling of a steel product in a continuous manufacturing line. The invention also relates to the installation for performing the method.

### BACKGROUND

In the steel industry, many processes that occur at high temperature leave an oxide layer or scale on the product surface. In particular, prior to cold rolling operation, hot rolled steel has to be passed through a pickling line so as to remove the scale from its surface. Presently pickling is more and more the bottleneck process when coupled to the cold rolling mill (Pickling Line Tandem Cold Mill - PLTCM).

Several acid pickling media have been used depending on the specific product to pickle (sulfuric, hydrochloric, hydrofluoric, nitric acids, etc.). However acid pickling of carbon steel is usually limited to pickling with a hydrochloric solution.

Nowadays, steels are more and more alloyed, especially with silicon and manganese. Steels containing silicon are especially prone to the formation of fayalite (orthorhombic iron silicate Fe2SiO4) during reheating of the slab. Fayalite becomes liquid above 1173° C., which is always the case in reheating furnaces (T>1200° C.). This liquid phase infiltrates the oxide down to the steel-oxide interface and “sticks” to the metal. Fayalite is difficult to remove during hydraulic descaling (hot rolling process). In particular, when present at the entry of the pickling line, Fayalite is very difficult to be removed by the HCl pickling liquor because of its low solubility.

When such products enter the pickling line, the strip speed has to be reduced in order to ensure a certain pickling time necessary to remove the oxide layer. In the worst cases very low pickling speeds are even not sufficient to remove all the oxides and specifically fayalite from the steel surface.

Pickling of a steel strip is a chemical process based on the dissolution of oxides in acid (with HCl concentration usually between 30 and 180 g/l) at a temperature up to 80° C. Oxide dissolution increases with acid concentration, temperature and turbulence of the pickling liquor:
acid concentration is managed by a cascade of tanks containing pickling media from a last tank to a first one of the line. Fresh acid (180 g/l) is fed in the last pickling tank, with liquid in countercurrent circulation in respect of solid product;
as a temperature of 80° C. is usually the maximum temperature used in HCl pickling process, temperature can hardly be increased well above when using polypropylene (PP) for manufacturing the tanks, which equips more and more lines;
increasing turbulence is precisely the purpose of the present patent application: increasing turbulence to refresh more rapidly the free acid in the electric double layer directly increases the pickling process efficiency.

Several pickling methods are known in the art for removing scale:
deep tank pickling: the steel strip is dipped in acid solution in deep working tanks and with a large catenary size only supported by inlet and outlet skids. The acid solution presents extremely slow flow motion;
shallow tank pickling: the size of steel strip catenary is reduced as well as the depth of acid fluid. The acid fluid circulates largely with the steel strip inside the tank and the relative flow rate between the strip and the acid fluid is small, causing limitation to increase pickling speed;
in TurbofloTM pickling lines developed by Danieli, US (WO 00/71267 A1), where pickling tanks are divided in a number of cells, the descaling process is accelerated thanks to turbulence created by sprays at the entry, the exit and at the sides and by changes of the cell section of the channel;
in US 5,545,260 A (SMS), turbulence is created by high pressure (3 bar) spray headers located at the inlet and at the outlet of the tank;
in EP 3 029 164 B1 (CMI UVK GmbH), there is combination of a spraying tank (P < 3 bar, spray headers located every 40-50 cm) in cascade with an immersion tank. Speed is increased with turbulence;
in the iBox pickling tank of Primetals, the acid solution is circulated by strip running effect and continuously heated up by internal heat exchangers. External circulation system and heat exchanger are not required and as a result, iBox pickling tank has the benefits of low maintenance and radiation losses, low clogging risk as well as rapid heating up. However turbulence is only controlled by strip velocity;
as an alternative to acid pickling, in the EPS technology (Eco pickled surface, The Material Works, see e.g. US 8, 066,549 B2), slurry blasts are propelled on the strip in uniform streams. Slurry blasting is a wet abrasive blasting process that combines a fine-particle metallic abrasive with a carrier liquid, most commonly water. The slurry mixture is fed into a rotating impeller which propels it at high velocity across the object to be cleaned. Its advantages are to be well suited for processing a large product mix on the same line (carbon steel, stainless steel, alloyed steel, etc.), no overpickling, to provide a rust resistant surface without oiling and a more homogeneous surface aspect. However that is a slow process, with higher roughness and need for slurry blasts regeneration.

Highly turbulent technologies which are further investigated in this application have been considered for a long time for cooling purposes. As a matter of fact, since the 1980′s, the Applicant has studied the opportunity to apply cooling technologies with very high cooling power (up to 5 MW/m2), firstly for high-strength plates and secondly for rolling mill rolls, which are alternative to conventional cooling technologies (see e.g. H. Uijtdebroeks et al., High turbulence roll cooling, European Commission, contract No 7215-PP/075, 2002-2005, Final report EUR 22972). As such a very high cooling power cannot be obtained by normal laminar jet nozzles, high turbulence cooling technologies were investigated. Cooling heads have been designed to operate on the one side in so-called “high turbulence low pressure regime” (HTLP) and on the other side in so-called “water pillow cooling” (WPC). The distance between the header and the plate, strip or roll determines whether the dominant cooling effect will be obtained through either WPC or HTLP or a combination of both. HTLP requires a much smaller plate, strip or roll/header gap distance compared to WPC. The smaller gap creates a higher degree of turbulence. Therefore it results in a significant increase in thermal exchange.

In HTLP cooling, the cooling header is located at close distance of the strip, plate or roll surface, typically 3-4 mm. The electrolyte, e.g. water or water solution, is injected in a central gap and forced to flow between the roll or strip surface and the cooling module. The pursued principle is also to create a high turbulence in the gap between the surface and the header so as to increase thermal exchange between the surface and the cooling liquid.

The WPC cooling has been developed to perform selective cooling of long and flat products having a high heat transfer coefficient. The WPC cooling device is placed at short distance, typically of 10 to 100 mm from the surface to cool. Owing to this close distance and thanks to water projection, a water cushion is formed between the module and the surface. Injection of straight water jets through holes drilled in the header maintains the cushion while creating high turbulence therein. The particularity is that high heat transfer coefficients are obtained at low pressure. With WPC a very homogeneous cooling pattern is obtained over the whole surface to cool. This homogeneity is related to the number of straight water jets in the header, the cooling pattern and the applied pressure. The required operating pressure typically varies from 2 to 5 bar. The thickness of the water cushion varies from 10 to 100 mm.

The cooling efficiency is strongly influenced by the total amount of water injected. The performance increases with the increase of water flow, if necessary combined with side guides. For the same heat flux during cooling a lower flow rate and pressure are required compared to the traditional flat jet spray cooling configurations.

The Applicant has obtained efficient cooling of the work rolls in flat and long product mills thanks to the application of a breakthrough technology called “High Turbulence Roll Cooling” (HTRC) (patented under EP 2 114 584 B1). In this concept, a turbulent water cushion is formed around the work roll surface with a controlled and forced water circulation. This technology has continuously been improved over the last years. Besides the possibility to control the distance between the cooling header and the work roll surface ( position-controlled HTRC), the turbulence of the water is created combining the water pillow cushion technology and the high turbulent low pressure cooling principle. For a similar flow rate, the heat transfer coefficient is increased by 25% compared to the first generation of HTRC and by more than the double compared to a traditional roll cooling system with flat jet nozzles operating up to 15 bar. As the enhanced HTRC unit operates at a low pressure (2 to 3 bar), the energy saving reaches values close to 85 to 90% compared to a conventional cooling system.

Document US 4,270,317 A discloses an apparatus used in the treatment of a sheet of metal, in which the sheet of metal is guided in a horizontal pathway between successive treatment tanks or units having horizontally elongated chambers with two rows of oppositely disposed and horizontally aligned nozzles between which the sheet of metal travels on a liquid bed that is created by the nozzles which are designed to direct streams of liquid, under pressure, against the traveling metal sheet at angles that are substantially less than 90° relative to the plane in which the metal sheet travels. A unique liquid seal and conventional blowoff device are utilized at each opening through which the traveling metal sheet enters and exits the various chambers, as a means of maintaining the liquid within the chamber and preventing it from being carried away by the traveling metal sheet into an adjacent chamber where the appearance of such liquid may have a deleterious effect upon the process being carried out in that particular chamber. The individual units are also free of brushes and other such devices which are normally used to aid in the cleaning of the sheet of metal.

Document EP 1 008 676 A2 discloses a process and a device for the continuous pickling in a non-oxidizing acid bath of hot-rolled steel strips, characterised in that the strip is subject to the pickling action of the bath, additioned of a pickling catalyst, under turbulent conditions. This device comprises the following in combination: a closed storage tank containing the catalyst-additioned pickling bath; at least one cell, located above the free surface of the pickling bath, inside which the strip to be pickled, possibly guided by supporting rolls, travels horizontally; immersed nozzles, provided above and below the strip, located and shaped so as to feed under pressure the pickling bath to the cell, to create a directional flow of the pickling bath itself that generates the required turbulent conditions; means for drawing the pickling bath from the tank and delivering it to the nozzles; and means for recirculating the pickling bath from the cell to the tank.

Document WO 2020/217180 A1 concerns a continuous pickling process and plant for the treatment of metal products in the form of a strip or tube. The device includes a plurality of acid solution process tanks each divided into a plurality of turbulence cells and a recirculation system of the acid solution. The plant also includes, upstream of the plurality of process tanks, a device for heating the metal product, namely an induction heating system and/or a tunnel with water sprays. Devices are described to increase turbulence in the tanks and to accelerate pickling, e.g. by adding fresh acid in the first tank. The invention optimizes the effect of the acid and reduces the residence time of the strip in the plant.

### SUMMARY

In an embodiment, the present invention provides a pickling installation for applying a pickling treatment to a metal strip in continuous movement, the pickling treatment using an acid solution, the pickling installation comprising: a plurality of cascading treatment tanks among which at least one treatment tank comprises a spray/injection section for spraying/injecting the acid solution on the metal strip; and collection means for retrieving the sprayed acid solution after use and redirecting the sprayed acid solution to each spray/injection section, wherein the at least one treatment tank comprises a first header in front of a first face of the metal strip and a second header in front of a second face of the metal strip, wherein, in a first treatment tank configuration, each of the first header and the second header have an internal flat surface intended to be parallel respectively to first and second faces of metal strip, and at a distance thereof, defining a first gap and a second gap respectively, the first header and the second header each comprising a plurality of holes drilled through the internal flat surface according to a defined 2D-pattern, for spraying the acid solution to the metal strip in straight jets, under conditions suitable to create at the surface of the metal strip a highly turbulent liquid cushion, or alternately, wherein, in a second treatment tank configuration, each of the first header and the second header have an internal flat surface intended to be parallel respectively to first and second faces of the metal strip, and at a distance thereof, defining a first gap and a second gap respectively, acid solution injection means being provided at an edge injection opening of each respective gap, under conditions suitable to create in use at the surface of the metal strip a highly turbulent liquid zone occupying the whole respective gap volume, or alternately, wherein a third treatment tank configuration combines the first treatment tank configuration and the second treatment tank configuration, and wherein, either in the first treatment tank configuration or in the second treatment tank configuration, the internal flat surface, except at locations of the holes drilled therein in case of the first treatment tank configuration, is continuous.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view representing a metallurgical pickling line according to prior art.

FIG. 2A is a schematic cross-sectional longitudinal view representing the principle of acid pickling under high turbulence WPC conditions applied to a moving metal strip.

FIG. 2B is a schematic cross-sectional longitudinal view representing the principle of acid pickling under high turbulence HTLP conditions applied to a moving metal strip.

FIG. 2C is a schematic cross-sectional longitudinal view representing the principle of acid pickling under high turbulence respective WPC and HTLP conditions applied to a moving metal strip.

FIG. 3 is a schematic cross-sectional longitudinal view representing the principle of acid pickling under high turbulence respective WPC and HTLP conditions applied to a moving metal strip, in presence of abrasive particles in the tank solution.

FIG. 4 is a picture of the jet impacts (primary and secondary turbulence), having the form of a honeycomb, according to the first configuration of the invention.

FIG. 5 diagrammatically shows the average heat transfer coefficient in function of the average flow density for cylinder cooling installations using HTRC technology in comparison with those using high pressure flat jet sprays technology.

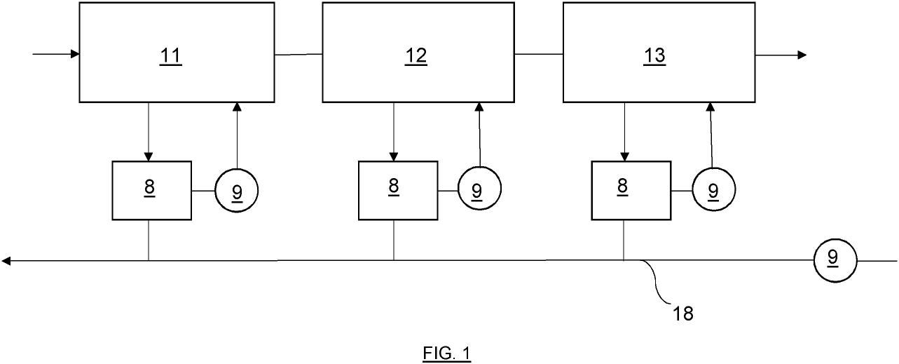

### DETAILED DESCRIPTION

In an embodiment, the present invention provides a pickling installation and method for manufacturing metal products such as steel strips with reduced pickling time, especially in presence of hard to remove oxides such as fayalite on the steel surface.

In an embodiment, the present invention provides a pickling installation for applying a pickling treatment to a steel strip (10) in continuous movement, said pickling treatment using an acid solution, said pickling installation comprising:
a plurality of cascading treatment tanks among which at least one treatment tank comprising a spray/injection section for spraying/injecting the acid solution on the metal strip, and
collection means for retrieving the sprayed acid solution and redirect the same to each spray/injection section;
the at least one treatment tank comprising a first header in use in front of a first face of the metal strip and a second header in use in front of a second face of the metal strip, wherein:
in a first treatment tank configuration, each of the first header and the second header have an internal flat surface intended to be parallel respectively to the first and second faces of the metal strip, and at a distance thereof, defining a first gap and a second gap respectively, said first header and said second header comprising each a plurality of holes drilled through the internal flat surface according to a defined 2D-pattern, for spraying the acid solution to the metal strip in straight jets, under conditions suitable to create in use at the surface of the metal strip a highly turbulent liquid cushion, or alternately;
in a second treatment tank configuration, each of the first header and the second header have an internal flat surface intended to be parallel respectively to the first and second faces of the metal strip, and at a distance thereof, defining a first gap and a second gap respectively, acid solution injection means being provided at an edge injection opening of each respective gap, under conditions suitable to create in use at the surface of the metal strip a highly turbulent liquid zone occupying the whole gap volume, or alternately;
a third treatment tank configuration combines the first treatment tank configuration and the second treatment tank configuration;
and wherein, either in the first treatment tank configuration (1A) or in the second treatment tank configuration (1B), said internal flat surface (6), except at the locations of the holes drilled therein in case of the first configuration (1A), is continuous.

It should be noted that a distinction is made between generally multi-jet sprays, as in the first configuration, and slot injector(s), as in the second configuration.

According to particular embodiments, the pickling installation further comprises at least one of the following characteristics or a suitable combination thereof:
the collection means comprise at least one storage tank and at least one pump as well as means for injecting fresh acid into the pickling tanks in counter-current in respect of the cascading direction;
the pickling installation comprises at least one other treatment tank;
the at least one other treatment tank is an immersion or a rinsing treatment tank;
lateral side guides are provided for maintaining the liquid cushion or the highly turbulent zone in the gap or the first and the second gaps are designed to form a tunnel having a width equal to the width of the line;
the at least one pump is made of a material able to resist to abrasive particles present inside the acid solution, selected from the group consisting of ceramic, graphite, polyvinylidene fluoride (PVDF), and polytetrafluoroethylene (PTFE);
the at least one pump is designed so that the abrasive particles are injected by venturi effect after a pump outlet;
the first gap and the second gap are different, in particular the first gap is greater than the second gap;
the injection means being provided at an edge injection opening of the gap are cocurrent or counter-current to the strip, in this last case to increase the relative speed between the strip and pickling flow.

A second aspect of the present invention relates to a method for applying a pickling treatment to a metal strip in continuous movement, using the pickling installation according to anyone of the preceding claims, wherein it comprises the steps of:
providing the pickling installation with an acid solution;
directing the moving metal strip into at least one treatment tank comprising a spraying/injection section for spraying/injecting the acid solution on the metal strip, and spraying/injecting the acid solution on both faces of the metal strip under high turbulence conditions;
retrieving the acid solution sprayed on the metal strip and redirecting again the same to the spraying sections using the collection means.

According to particular embodiments, the pickling method further comprises at least one of the following characteristics or a suitable combination thereof:
the metal strip is further directed to be treated in one or more other treatment tanks;
the metal strip is a steel strip, selected from the group consisting of a carbon steel strip, a stainless steel strip, and an alloyed steel strip;
the acid solution used is a hydrochloric acid, sulphuric acid, nitric acid, phosphoric acid, hydrofluoric acid solution or an organic, such as formic, acid solution;
acid insoluble abrasive mineral particles are added to the acid solution;
the Mohs hardness of the acid insoluble abrasive mineral particles is comprised between 4 and 7, and preferably is greater than or equal to 5;
the acid insoluble abrasive mineral particles are selected from the group consisting of corundum, glass microballs, alumina, silicate, silicon carbide and zirconium;
the flow rate of the sprayed/injected acid solution is selected so as to obtain in the first tank configuration a thickness of the highly turbulent liquid cushion equal to the thickness of the gap;
the maximum temperature of the acid solution is about 80° C., for example in case of use of polypropylene, PVDF, PTFE tanks;
the abrasive particles are recovered at the end of the process, for example by filtration or decantation.

According to a particular embodiment, the metallurgical line and thus the continuous strip movement is horizontal. In this case, the first header, the second header respectively, is an upper header, respectively a lower header. Further the first face of the strip, the second face of the strip respectively, is an upper face, a lower face respectively.

According to another embodiment, the metallurgical line and thus the continuous strip movement is vertical.

In the pickling method according to a first embodiment of the present invention, turbulence of the pickling solution is increased through the WPC and/or HTLP principles or a combination of both technologies.

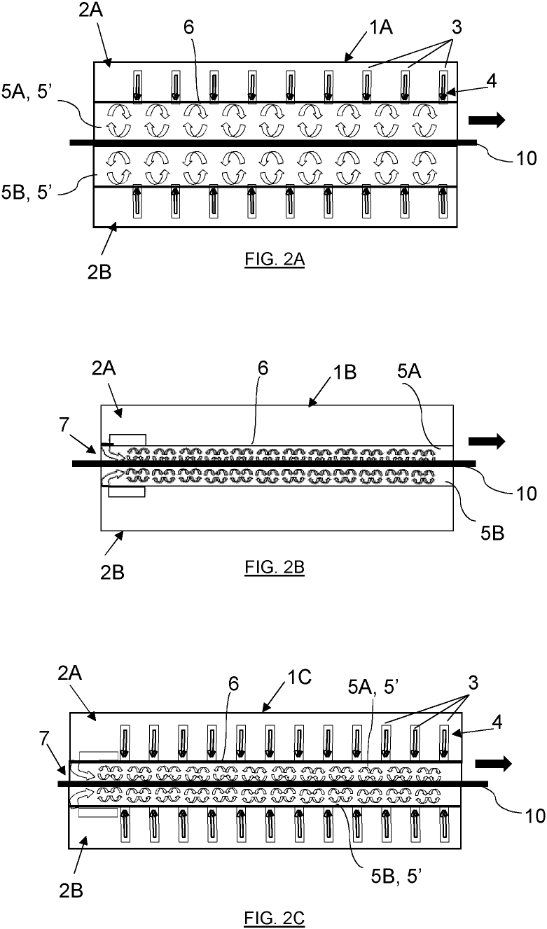

Accordingly, as schematically represented in FIG. 2A, a WPC highly turbulent regime is applied to the acid solution present in one or more tanks of the pickling installation.

Let us consider the pickling process of a metal strip 10, such as a steel strip, in horizontal processing. The method could also be applicable to long products. The pickling installation comprises a number N of tanks into which the metal strip 10 moves successively on rolls (not represented). Each (or at least one) tank 1A comprises an upper header 2A in front of the upper face of the strip and a lower header 2B in front of the lower face of the strip. Each header 2A, 2B comprises holes 3 drilled in the header 2A, 2B through which injection of straight water jets 4 is performed at high flow rate so as to maintain a liquid cushion 5′ in the respective upper gap 5A and lower gap 5B between the headers 2A, 2B and the strip, with high turbulence therein. The jets are straight jets and not flared jets such as those obtained with ordinary flat nozzles. The height of the liquid cushion 5′, typically 10-100 mm, can be lower than the distance 5A, 5B separating the internal header surface 6 and the strip 10.

When using WPC, pressure will be in the range 1 to 5 bars and the specific flow rate in the range of 30 to 300 m³/h/m² of surface.

Alternatively, as schematically represented in FIG. 2B, a HTLP highly turbulent regime is applied to the acid solution present in (a) tank(s) 1B of the pickling installation (FIG. 2C shows an embodiment with the combined use of both principles cites here above). In this case, the internal header surface 6 is located very close to the strip (typically 2-5 mm) and the electrolyte is forced to enter the gap 5A, 5B between the header plate 6 and the strip 10, through one opening 7 located at one side of the device, creating thereby a highly turbulent zone.

When HTLP is used, pressure will be in the range of 0.5 to 2 bars and the specific flow rate per side in the range of 50 to 120 m³/h/m of width.

Note that, for either WPC or HTLP, the value of the pressure obtained is linked to the specific flow rate by the design of the nozzles or slot injector, as the case may be.

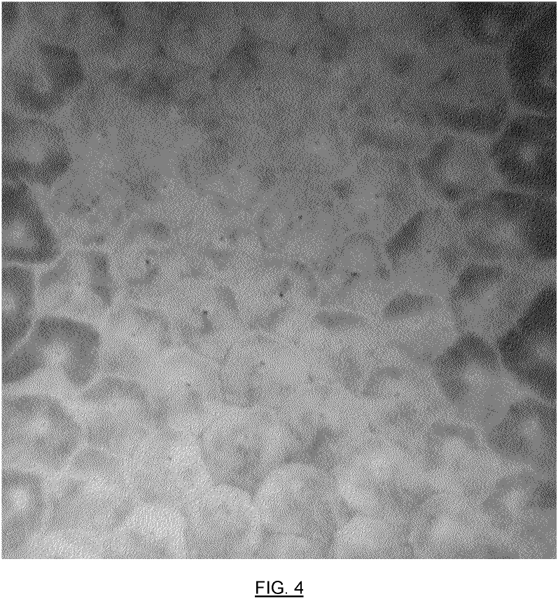

According to the present invention, the use of a multi-perforated plate allows to create a more important and homogeneous turbulence by a double effect: the impact of the jets (primary turbulence) and the very important agitation of liquid between the jets following the collision of the jets coming from the nozzles (secondary turbulence). In the first configuration (WPC), honeycomb-like impacts can be observed (see FIG. 4).

The geometries according to the present invention are clearly specific and stand out from prior art of pickling units. While some create length-variable turbulence using alternating equipment geometry (such as in US 4 270 317 with turbulators or EP 1 008 676 with flat jet sprays), the present invention discloses a much simpler continuous geometry under the form of a tunnel with a flat internal surface which, with an homogeneous distribution of the perforations, especially in first and third treatment tank configurations, creates a continuous, regular and homogeneous turbulence at the surface of the strip and over the entire length of the strip. Prior art technologies are not continuous and homogeneous over the length of a unit considering their configuration of alternating equipment or sprays.

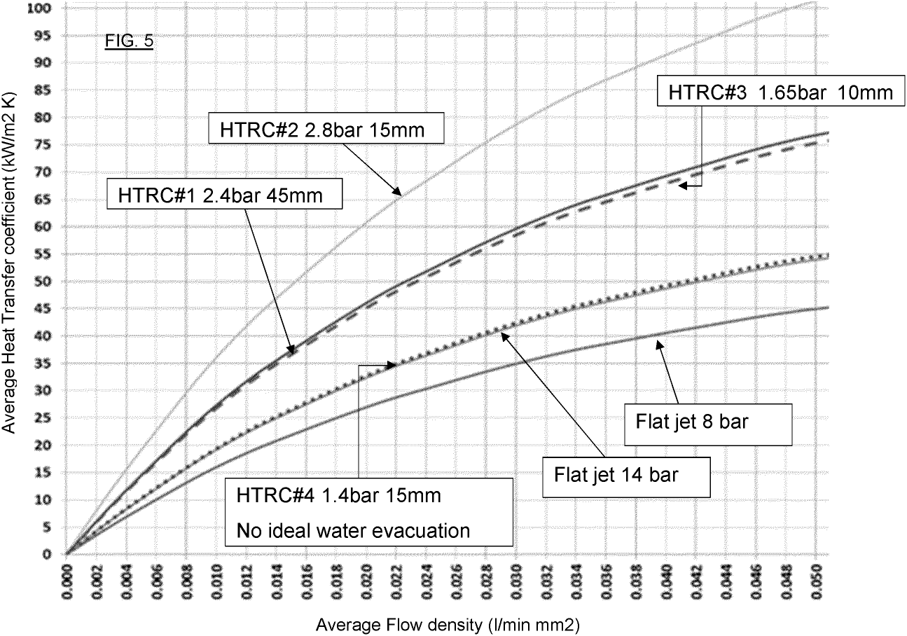

The spacing between the headers and the strip is also one parameter to be taken in consideration when comparing the present invention with prior art. FIG. 5 shows the results of back-calculation of the heat exchange coefficient in cylinder cooling using HTRC technology vs. high pressure flat jet sprays. In cylinder cooling, HTRC is a combination of a perforated plate (WPC technology) with slot injection (HTLP technology). For a gap of 45 mm or 15 mm the heat exchange is clearly more important in HTRC compared to flat sprays. By analogy, the pickling configurations of the present invention can also be considered more efficient than those of prior art.

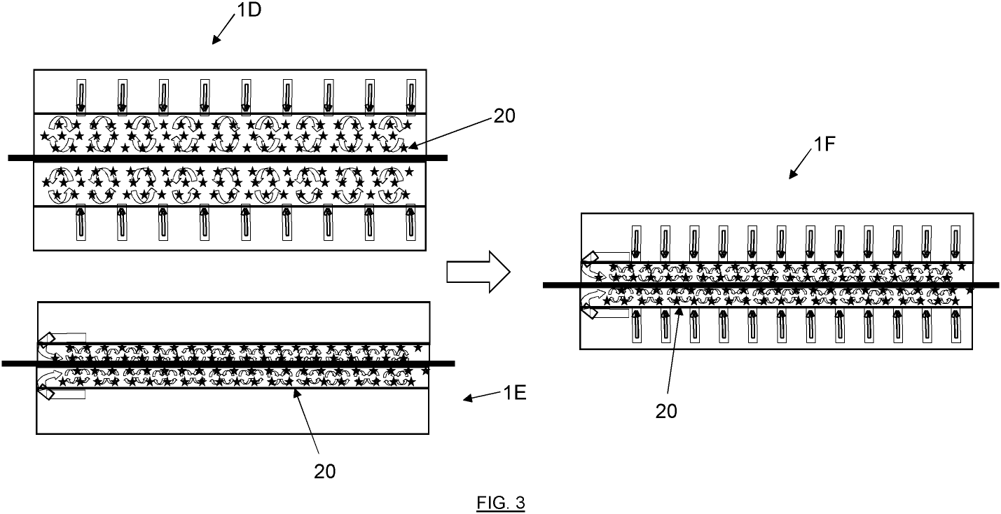

In a second embodiment, beside the chemical action of acid and in addition of it, in order to further and efficiently assist in the removal of hard to dissolve oxides like fayalite, the inventors further assert that a mechanical action would help for strengthening removal of this kind of oxide. Such a mechanical action is intended under the form of an addition of abrasive particles 20 propelled on the strip surface in a highly turbulent tank (FIG. 3) so as to further decrease the pickling time.

Preferably, abrasive particles 20 non-soluble in acid, such as corundum, glass microballs, alumina, silicate, silicon carbide, zirconium, etc., will be used. The Mohs hardness of the acid insoluble abrasive mineral particles 20 will be comprised between 4 and 7, and preferably will be higher or equal to 5. Particles with Mohs hardness of 5 minimum have excellent resistance to HCl at all useful concentrations and temperatures.

In this case, an innovation consists in using a double action made of a chemical action and a mechanical action respectively due to acid and abrasive particles to optimize the reduction of pickling time.

So the materials used in the pickling installation will be suitably chosen so as to resist to the pickling media, acid and abrasive particles.

Advantageously, the abrasive particles will be recovered at the end of the process for example by filtration or decantation.

FIG. 3 schematically represents the principle of acid pickling under high turbulence with respective WPC and HTLP conditions, as described above, applied to a moving metal strip, but now in additional presence of abrasive particles in the tank solution.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Reference symbols

| 1A | WPC acid pickling tank |
|---|---|
| 1B | HTLP acid pickling tank |
| 1C | WPC and HTLP acid pickling tank |
| 1D | WPC acid pickling tank with abrasive particles |
| 1E | HTLP acid pickling tank with abrasive particles |
| 1F | WPC and HTLP acid pickling tank with abrasive particles |
| 2A, 2B | Upper header, lower header (horizontal processing) |
| 3 | Hole drilled in header (WPC) |
| 4 | Straight jet (WPC) |
| 5A, 5B | Upper gap, lower gap (horizontal processing) |
| 5′ | Liquid cushion |
| 6 | Header internal flat surface |
| 7 | Injection opening (HTLP) |
| 8 | Acid solution tank |
| 9 | Pump |
| 10 | Metal strip |
| 11, 12, 13, .. | Pickling treatment tank |
| 18 | Injection line for fresh acid |
| 20 | Abrasive mineral particle |

1. A pickling installation for applying a pickling treatment to a metal strip in continuous movement, the pickling treatment using an acid solution, the pickling installation comprising:
a plurality of cascading treatment tanks among which at least one treatment tank comprises a spray/injection section for spraying/injecting the acid solution on the metal strip; and
collection means for retrieving the sprayed acid solution after use and redirecting the sprayed acid solution to each spray/injection section,
wherein the at least one treatment tank comprises a first header in front of a first face of the metal strip and a second header in front of a second face of the metal strip, wherein,
in a first treatment tank configuration, each of the first header and the second header have an internal flat surface intended to be parallel respectively to the first and second faces of metal strip, and at a distance thereof, defining a first gap and a second gap respectively, the first header and the second header each comprising a plurality of holes drilled through the internal flat surface according to a defined 2D-pattern, for spraying the acid solution to the metal strip in straight jets, under conditions suitable to create in use at the surface of the metal strip a highly turbulent liquid cushion, or alternately,
wherein, in a second treatment tank configuration, each of the first header and the second header have an internal flat surface intended to be parallel respectively to the-first and second faces of the metal strip, and at a distance thereof, defining a first gap and a second gap respectively, acid solution injection means being provided at an edge injection opening of each respective gap, under conditions suitable to create at the surface of the metal strip a highly turbulent liquid zone occupying the whole respective gap volume, or alternately,
wherein a third treatment tank configuration combines the first treatment tank configuration and the second treatment tank configuration, and
wherein, either in the first treatment tank configuration or in the second treatment tank configuration, the internal flat surface, except at locations of the holes drilled therein in case of the first treatment tank configuration, is continuous.

2. (canceled)

3. The pickling installation according to claim 1, wherein the collection means comprise at least one storage tank and at least one pump as well as means for injecting fresh acid into the pickling tanks in counter-current in respect of a cascading direction.

4. The pickling installation according to claim 1, further comprising:
at least one other treatment tank.

5. The pickling installation according to claim 3, wherein the at least one other treatment tank comprises an immersion or a rinsing treatment tank.

6. The pickling installation according to claim 1, wherein lateral side guides are provided for maintaining the liquid cushion or the highly turbulent zone in the gap, or
wherein the first and the second gaps are designed to form a tunnel having a width equal to the width of the line.

7. The pickling installation according to claim 3, wherein the at least one pump comprises a material able to resist to abrasive particles present inside the acid solution, selected from a group consisting of ceramic, graphite, polyvinylidene fluoride, and polytetrafluoroethylene.

8. The pickling installation according to claim 3, wherein the at least one pump is designed so that the abrasive particles are injected by venturi effect after a pump outlet.

9. The pickling installation according to claim 1, wherein the first gap and the second gap are different.

10. The pickling installation according to claim 1, wherein the injection means are provided at an edge injection opening of the gap co-current or counter-current to the strip, in this last case to increase the relative speed between the strip and pickling flow.

11. A method for applying a pickling treatment to a metal strip in continuous movement, using the pickling installation according to claim 1, the method comprising:
providing the pickling installation with the acid solution;
directing the moving metal strip into the at least one treatment tank comprising athe spray/injection section for spraying/injecting the acid solution on both faces of the metal strip under high turbulence conditions; and
retrieving the acid solution sprayed on the metal strip and redirecting again the acid solution to the spray/injection section using the collection means.

12. The pickling method according to claim 11, wherein the metal strip is further directed to be treated in one or more other treatment tanks.

13. The pickling method according to claim 11, wherein the metal strip comprises a steel strip selected from a group consisting of a carbon steel strip, a stainless steel strip, and an alloyed steel strip.

14. The pickling method according to claim 11, wherein the acid solution used comprises a hydrochloric acid, sulphuric acid, nitric acid, phosphoric acid, hydrofluoric acid solution or an organic, such as formic, acid solution.

15. The pickling method according to claim 11, wherein acid insoluble abrasive mineral particles insoluble in acid are added to the acid solution.

16. The pickling method according to claim 15, wherein a Mohs hardness of the acid insoluble abrasive mineral particles is between 4 and 7.

17. The pickling method according to claim 15, wherein the acid insoluble abrasive mineral particles are selected from a group consisting of corundum, glass microballs, alumina, silicate, silicon carbide, and zirconium.

18. The pickling method according to claim 11, wherein a flow rate of the sprayed/injected acid solution is selected so as to obtain in the first tank configuration a thickness of the highly turbulent liquid cushion equal to the-a thickness of the gap.

19. The pickling method according to claim 11, wherein the-a maximum temperature of the acid solution is 80° C., in case of use of polypropylene, PVDF, PTFE tanks.

20. The pickling method according to claim 11, wherein the abrasive particles are recovered at an end of the process, by filtration or decantation.
